(19) United States
(12) Patent Application Publication
(10) Pub. No.: US 2023/0347402 A1
(43) Pub. Date: Nov. 2, 2023

(54) METHOD AND ARRANGEMENT FOR FORMING A LIP SKIN FOR A NACELLE

(71) Applicant: Rohr, Inc., Chula Vista, CA (US)

(72) Inventors: Michael Ludlow, Belfast (IE); David McCracken, Belfast (IE)

(73) Assignee: Rohr, Inc., Chula Vista, CA (US)

(21) Appl. No.: 18/115,535

(22) Filed: Feb. 28, 2023

(30) Foreign Application Priority Data
Apr. 28, 2022 (GB) 2206204.6

(51) Int. Cl. B21D 22/22; B64F 5/10; B21D 53/92

(52) U.S. Cl. CPC B21D 22/22; B64F 5/10; B21D 53/92

(57) ABSTRACT

An arrangement for forming an annular component includes a small diameter clamp for securely retaining a first holding surface of a small diameter end of a preform, a large diameter clamp for securely retaining a second holding surface of a large diameter end of the preform, and a punch having an external surface contour shaped to correspond to a shape of a profile of the annular component. The small diameter clamp and/or the large diameter clamp is configured to clamp the respective small and/or large holding surface, respectively, at an angle other than a slant angle of a main frusto-conical portion of the preform.

### CROSS-REFERENCE TO RELATED APPLICATIONS

This application claims priority to, and the benefit of, GB Patent Application No. 2206204.6 (DAS CODE: C2B2), filed Apr. 28, 2022 and titled “A METHOD AND ARRANGEMENT FOR FORMING A LIP SKIN FOR A NACELLE,” which is incorporated by reference herein in its entirety for all purposes.

### FIELD

The present disclosure relates to aerospace manufacturing, and more specifically, to a method and arrangement for forming a nacelle lip skin.

### BACKGROUND

Aircraft nacelles house components such as the jet engines and are shaped to optimize laminar flow. Air flow is guided into the engine at the leading edge of the nacelle which comprises a lip skin. In order to maintain optimum air flow to the engine and reduce laminar drag and turbulence, it is important that the lip skin is smooth and free from inconsistencies. The geometry of lip skins must also be formed to enable adjustment of air flow to the engine depending on flight stage and differing angles of attack, during flight.

Lips skins may be manufactured of a high strength metal or metal alloy such as aluminum, titanium, or stainless steel from a single piece or multiple sectors. Typically, the process of lip skin forming involves complex and expensive processes such as multi-stage deep drawings or spin forming processes

### SUMMARY

In one aspect, an arrangement for forming an annular component includes a small diameter clamp for retaining a first holding surface of a small diameter end of a preform, the preform comprising a main frusto-conical portion, the small diameter end having the first holding surface, and a large diameter end having a second holding surface, a large diameter clamp for retaining the second holding surface of the large diameter end of the preform, and a punch having an external surface contour shaped to correspond to a shape of a profile of the annular component. At least one of the large diameter clamp or the small diameter clamp is configured to clamp the holding surface at an angle other than a slant angle of the main frusto-conical portion of the preform.

In various embodiments, the large diameter clamp comprises an external die and an external blank holder configured to receive the second holding surface therebetween.

In various embodiments, the small diameter clamp comprises an internal die and an internal blank holder configured to receive the first holding surface therebetween.

In various embodiments, the punch, the small diameter clamp, and the large diameter clamp are configured to move coaxially relative to one another to form the annular component from the preform.

In various embodiments, the small diameter clamp is configured to clamp the first holding surface at a first angle other than the slant angle of the main frusto-conical portion of the preform.

In various embodiments, the first holding surface of the small diameter end projects inwardly from the main frusto-conical portion.

In various embodiments, the second holding surface of the large diameter end projects outwardly from the main frusto-conical portion.

In various embodiments, the first holding surface of the small diameter end extends from a circumference of the small diameter end at a first angle other than the slant angle of the frusto-conical portion.

In various embodiments, the second holding surface of the large diameter end extends from a circumference of the large diameter end at the angle other than the slant angle of the frusto-conical portion.

In various embodiments, the angle is in a range of 30° above or below an angle that is perpendicular to a longitudinal axis of the main frusto-conical portion of the preform.

In various embodiments, the angle is perpendicular to the longitudinal axis of the main frusto-conical portion of the preform.

In various embodiments, one of the external die or the external blank holder comprises a projection and the other of the external die or the external blank holder comprises a groove, wherein in response to the external die and the external blank holder being moved towards one another the projection becomes interlocked with the groove so that the second holding surface is clamped between the clamping surfaces of the external die and the external blank holder at the angle other than the slant angle of the main frusto-conical portion.

In various embodiments, the annular component is a lip skin for a nacelle.

In another aspect a method of forming an annular component is disclosed, the method comprising the steps of a) clamping at least one of a first holding surface or a second holding surface at an angle other than a slant angle of a main frusto-conical portion of a preform, wherein the preform comprises the main frusto-conical portion, a small diameter end having the first holding surface, and a large diameter end having the second holding surface, and b) drawing the preform over a punch to form the annular component.

In various embodiments, the step of clamping at least one of the first holding surface or the second holding surface comprises clamping the second holding surface of the large diameter end with a large diameter clamp at the angle other than the slant angle of the main frusto-conical portion.

In various embodiments, the step of clamping at least one of the first holding surface or the second holding surface comprises clamping the first holding surface of the small diameter end with a small diameter clamp at the angle other than the slant angle of the main frusto-conical portion.

In various embodiments, the angle is in a range of 30° above or below an angle that is perpendicular to a longitudinal axis of the main frusto-conical portion of the preform.

In various embodiments, the angle is perpendicular to the longitudinal axis of the main frusto-conical portion of the preform.

In various embodiments, the method further comprises initiating coaxial movement between the punch, the large diameter clamp, and the small diameter clamp to form the lip skin.

In various embodiments, the method further comprises moving an external die of the large diameter clamp and an external blank holder of the large diameter clamp towards one another until a projection on a clamping surface of the external blank holder becomes interlocked with a groove on a clamping surface of the external die so that the second holding surface is clamped between the clamping surfaces of the external die and the external blank holder at the angle other than the slant angle of the main frusto-conical portion.

In another aspect, there is provided an arrangement for forming a lip skin for a nacelle from a preform having a main frusto-conical portion, a small diameter end having a holding surface and a large diameter end having a holding surface, the arrangement comprising a punch shaped to correspond to the shape of a lip skin, a small diameter clamp configured to clamp the preform at or about its small diameter end, a large diameter clamp configured to clamp the preform at or about its large diameter end, wherein the punch, small diameter clamp and large diameter clamp are configured to move coaxially relative to one another to form a lip skin, wherein the small diameter clamp is configured to clamp the small diameter end holding surface and/or the large diameter clamp is configured to clamp the large diameter end holding surface on the preform at an angle other than the slant angle of the main frusto-conical portion of the preform.

In various embodiments, the arrangement is configurable to form a lip skin with an extended trailing edge.

In various embodiments, the punch, the large diameter clamp, and the small diameter clamp are configured to move coaxially only, relative to one another.

In various embodiments, the apparatus comprises an actuation means to cause the punch, small diameter clamp and large diameter clamp to move coaxially, in relation to one another.

In various embodiments, the preform is formed of a single piece or multiple pieces with at least one joint.

In various embodiments, the preform is formed by extruding, spinning, casting, pressing, or rolling.

In various embodiments, the preform is formed by a shear forming process.

In various embodiments, the preform is formed by clamping a blank against an upper surface of a mandrel and rotating the clamp and mandrel. Force is applied to the blank via a shear forming tool which is traversed along the side of the mandrel to force the blank against the side of the mandrel.

In various embodiments, the mandrel is frusto-conical shaped having an upper end with a diameter smaller than the diameter of the lower end.

In various embodiments, the mandrel is trapezium in cross section.

In various embodiments, the blank is circular in shape.

In various embodiments, the shear forming tool exerts force on the blank at an area not clamped between the clamp and mandrel.

In various embodiments, the shear forming tool exerts force on the blank at a region of the blank contacting the circumference of the mandrel.

In various embodiments, the shear forming tool forces the blank along the slant of the mandrel such that a portion of the blank takes the shape of the mandrel to form a preform having a main frusto-conical portion.

In various embodiments, a portion of the blank maintains its planar shape such that the blank is formed into a preform having a main frusto-conical portion, a small diameter end having a holding surface and a large diameter end having a holding surface. In various embodiments, the preform is formed by any suitable manufacturing process for forming a conical or frusto-conical preform.

In various embodiments, the preform is a substantially frusto-conical blank.

In various embodiments, the holding surface of the large diameter end is located on a portion of the preform outside the main frusto-conical portion.

In various embodiments, the holding surface of the small diameter end is located on a portion of the preform inside the main frusto-conical portion.

In various embodiments, the main frusto-conical portion extends between the holding surface of the large diameter end and the holding surface of the small diameter end.

In various embodiments, the holding surface of the large diameter end forms a flange around the circumference of the preform at its large diameter end.

In various embodiments, the large diameter end holding surface extends from the circumference of the large diameter end of the main frusto-conical portion at an angle that is perpendicular to the longitudinal axis of the main frusto-conical portion of the preform.

In various embodiments, the large diameter end holding surface extends from the circumference of the large diameter end of the main frusto-conical portion at an angle that is in a range of 30° above or below an angle that is perpendicular to the longitudinal axis of the main frusto-conical portion of the preform.

In various embodiments, the holding surface of the small diameter end of the preform projects inwardly from the circumference of the small diameter end of the main frusto-conical portion.

In various embodiments, the holding surface of the small diameter end of the preform projects inwardly from the circumference of the small diameter end of the main frusto-conical portion towards a center of the main frusto-conical portion.

In various embodiments, the holding surface of the small diameter end of the preform projects inwardly from the circumference of the small diameter end of the main frusto-conical portion at an angle that is perpendicular to the longitudinal axis of the main frusto-conical portion of the preform.

In various embodiments, the holding surface of the small diameter end of the preform projects inwardly from the circumference of the small diameter end of the main frusto-conical portion at an angle that is in a range of 30° above or below an angle that is perpendicular to the longitudinal axis of the main frusto-conical portion of the preform.

In various embodiments, the small diameter clamp is configured to clamp the preform at the holding surface of the small diameter end of the preform at an angle other than the slant angle of the main frusto-conical portion of the preform.

In various embodiments, the small diameter clamp is configured to clamp the preform at the holding surface of the small diameter end of the preform at an angle that is perpendicular to the longitudinal axis of the main frusto-conical portion of the preform.

In various embodiments, the small diameter clamp is configured to clamp the preform at the holding surface of the small diameter end of the preform at an angle that is in a range of 30° above or below an angle that is perpendicular to the longitudinal axis of the main frusto-conical portion of the preform.

In various embodiments, the large diameter clamp is configured to clamp the preform at the holding surface of the large diameter end of the preform at an angle other than the slant angle of the main frusto-conical portion of the preform.

In various embodiments, the large diameter clamp is configured to clamp the preform at the holding surface of the large diameter end of the preform at an angle that is perpendicular to the longitudinal axis of the main frusto-conical portion of the preform.

In various embodiments, the large diameter clamp is configured to clamp the preform at the holding surface of the large diameter end of the preform at an angle that is in a range of 30° above or below an angle that is perpendicular to the longitudinal axis of the main frusto-conical portion of the preform.

In various embodiments, the holding surface of the large diameter end is flat, prior to clamping.

In various embodiments, the holding surface of the small diameter end is flat.

In various embodiments, the preform comprises an open end at its large diameter end.

In various embodiments, in one embodiment, the holding surface of the small diameter end of the preform comprises an aperture.

In various embodiments, the holding surface of the small diameter end of the preform comprises an aperture at or about its center.

In various embodiments, the holding surface of the small diameter end of the preform forms a ring around the aperture.

In various embodiments, the holding surface of the small diameter end of the preform forms an annular ring around the aperture.

In various embodiments, the aperture in the holding surface of the small diameter end of the preform allows material of the holding surface to expand radially outwardly away from the original aperture, increasing the size of the aperture as the preform is formed.

In various embodiments, during forming, the material of the holding surface around the circumference of the aperture expands uniformly away from the original aperture, increasing the size of the aperture while maintaining the shape of the aperture.

In various embodiments, the aperture enhances formability of the preform at its small diameter end away from the center of the preform, during forming.

In various embodiments, the holding surface of the small diameter does not comprise an aperture.

In various embodiments, the preform is formed into a lip skin using a single punch, large diameter clamp and small diameter clamp.

In various embodiments, the punch is annular.

In various embodiments, the external surface of the punch is shaped to correspond with the desired shape of the lip skin being formed.

In various embodiments, the large diameter clamp comprises an external die.

In various embodiments, the large diameter clamp comprises an external blank holder.

In various embodiments, the external die and the external blank holder are operable to move towards and/or away from one another.

In various embodiments, the external die and the external blank holder are operable to move towards and/or away from one another axially.

In various embodiments, the external die and the external blank holder are operable to move toward and/or away from one another coaxially.

In various embodiments, the external die is annular.

In various embodiments, the external blank holder is annular.

In various embodiments, the small diameter clamp comprises an internal blank holder.

In various embodiments, the small diameter clamp comprises an internal die.

In various embodiments, the internal blank holder and internal die are operable to move toward and/or away from one another.

In various embodiments, the internal blank holder and internal die are operable to move toward and/or away from one another axially.

In various embodiments, the internal blank holder and internal die are operable to move toward and/or away from one another coaxially.

In various embodiments, the internal blank holder is shaped to correspond to the shape of the punch.

In various embodiments, the internal blank holder comprises an arcuate clamping portion to correspond to the shape of the punch.

In various embodiments, the internal die is shaped to correspond to the shape of the punch.

In various embodiments, the internal die comprises an arcuate clamping portion to correspond to the shape of the punch.

In various embodiments, the internal blank holder and the internal die are the same in shape and size.

In various embodiments, the large diameter clamp comprises a lock bead to increase gripping capacity on the preform.

In various embodiments, the large diameter clamp comprises at least one projection and at least one groove to increase gripping capacity.

In various embodiments, the external blank holder of the large diameter clamp comprises a clamping surface.

In various embodiments, the clamping surface comprises a flat portion.

In various embodiments, the clamping surface comprises a projection.

In various embodiments, the clamping surface comprises an upward projection.

In various embodiments, in use, the clamping surface of the external blank holder is at an angle other than the slant angle of the main frusto-conical portion of the preform.

In various embodiments, in use, the clamping surface of the external blank holder is at an angle perpendicular to the longitudinal axis of the main frusto-conical portion of the preform.

In various embodiments, in use, the clamping surface of the external blank holder is at an angle that is in the range of 30° above or below an angle that is perpendicular to the longitudinal axis of the main frusto-conical portion of the preform.

In various embodiments, the external die comprises a clamping surface.

In various embodiments, the clamping surface comprises a flat portion.

In various embodiments, the clamping surface comprises a groove.

In various embodiments, the groove is shaped and located to correspond with the projection on the clamping surface of the external blank holder.

In various embodiments, in use, the clamping surface of the external die is at an angle other than the slant angle of the main frusto-conical portion of the preform.

In various embodiments, in use, the clamping surface of the external die is at an angle that is perpendicular to the longitudinal axis of the main frusto-conical portion.

In various embodiments, in use, the clamping surface of the external die is at an angle that is in a range of 30° above or below an angle that is perpendicular to the longitudinal axis of the main frusto-conical portion.

In various embodiments, the clamping surface of the external blank holder is shaped to correspond to a lower surface of the holding surface of the large diameter end of the preform and the clamping surface of the external die.

In various embodiments, the clamping surface of the external die is shaped to correspond with an upper surface of the holding surface of the large diameter end of the preform and the clamping surface of the external blank holder.

In various embodiments, the external die and external blank holder comprise an internal surface.

In various embodiments, the internal surface of the external die and external blank holder is shaped to correspond to the external surface of the punch to allow the punch to move past the internal surface of the external die and external blank holder during the lip skin forming process.

In various embodiments, the internal lower edge of the external die is curved to form a fillet radius.

In various embodiments, the internal upper edge of the external blank holder is curved to form a fillet radius.

In various embodiments, the fillet radius of the external die and external blank holder provides a smooth interface with the preform to reduce the risk of tearing of the preform as it is formed around the edge of the external die.

In various embodiments, in use, the external die and the external blank holder clamp the holding surface of the large diameter end of the preform at an angle other than the slant angle of the main frusto-conical portion of the preform.

In various embodiments, in use, the external die and the external blank holder clamp the holding surface of the large diameter end of the preform at an angle that is perpendicular to the longitudinal axis of the main frusto-conical portion of the preform.

In various embodiments, in use, the external die and the external blank holder clamp the holding surface of the large diameter end of the preform at an angle that is in a range of 30° above or below an angle that is perpendicular to the longitudinal axis of the main frusto-conical portion of the preform.

In various embodiments, the internal blank holder comprises a clamping surface.

In various embodiments, the arcuate clamping portion of the internal blank holder comprises a clamping surface.

In various embodiments, the clamping surface of the internal blank holder is flat.

In various embodiments, the internal die comprises a clamping surface.

In various embodiments, the arcuate clamping portion of the internal die comprises a clamping surface. the clamping surface of the internal blank holder is flat, the clamping surface of the internal die is flat.

In various embodiments, the internal die comprises a draw face.

In various embodiments, the draw face is formed as an integral part of the clamping surface of the internal die.

In various embodiments, the draw face is smooth.

In various embodiments, the internal blank holder and the internal die are shaped to optimize flow of the preform material, during forming.

In various embodiments, the outer lower edge of the internal die is curved to form a fillet radius.

In various embodiments, the outer upper edge of the internal blank holder is curved to form a fillet radius.

In various embodiments, the fillet radius of the internal blank holder and the internal die are smooth.

In various embodiments, the fillet radius of the internal die and the internal blank holder allows material of the holding surface of the small diameter end to flow away from the center of the small diameter end of the preform and out of an area between the internal blank holder and the internal die, over the punch during a second forming stage in the forming process.

In various embodiments, the fillet radius of the internal blank holder and the internal die allow the material of the holding surface of the small diameter end to bend smoothly around the fillet radius as it flows out of an area between the internal blank holder and the internal die during the second forming stage in the forming process.

In various embodiments, the fillet radius of the internal die and the internal blank holder enhances the ability of the preform material to flow away from its original position and reduces the risk of tearing of the material during forming. This is in comparison to an internal blank holder and internal die with non-smooth corners.

In various embodiments, in use, the clamping surface of the internal die is at an angle other than the slant angle of the main frusto-conical portion of the preform.

In various embodiments, in use, the clamping surface of the internal die is at an angle that is perpendicular to the longitudinal axis of the main frusto-conical portion of the preform.

In various embodiments, in use, the clamping surface of the internal die is at an angle that is in a range of 30° above or below an angle that is perpendicular to the longitudinal axis of the frusto-conical preform.

In various embodiments, in use, the clamping surface of the internal blank holder is at an angle other than the slant angle of the main frusto-conical portion of the preform.

In various embodiments, the clamping surface of the internal blank holder is at an angle that is perpendicular to the longitudinal axis of the main frusto-conical portion of the preform.

In various embodiments, the clamping surface of the internal blank holder is at an angle that in a range of 30° above or below an angle that is perpendicular to the longitudinal axis of the main frusto-conical portion of the internal blank holder.

In various embodiments, the external surface of the internal die is shaped to correspond to the internal surface of the punch with marginal room between for the preform.

In various embodiments, the preform is cold formed.

In various embodiments, the preform is heated or is pre-heated.

In various embodiments, at least a portion of the arrangement for forming a lip skin for a nacelle has a means for heating a preform in operable engagement therewith.

In various embodiments, the forming process occurs in a heated environment wherein the arrangement and preform are locatable within the heated environment.

Accordingly, in another aspect, the present disclosure provides a method of forming a lip skin for a nacelle comprising the steps of providing a preform having a main frusto-conical portion, a small diameter end having a holding surface, and a large diameter end having a holding surface and clamping the preform of the small diameter end holding surface and/or large diameter end holding surface wherein the clamping angle is an angle other than the slant angle of the main frusto-conical portion of the preform, the method further comprising drawing the preform over a punch to form a lip skin.

In various embodiments, the present disclosure provides a method of forming a lip skin with an extended trailing edge.

In various embodiments, the method comprises the step of clamping the large diameter end holding surface with the large diameter clamp at an angle other than the slant angle of the main frusto-conical portion.

In various embodiments, the method comprises the step of clamping the large diameter end holding surface with the large diameter clamp at an angle that is perpendicular the longitudinal axis of the main frusto-conical portion of the preform.

In various embodiments, the method comprises the step of clamping the large diameter end holding surface with the large diameter clamp at an angle that is in a range of 30° above or below an angle that is perpendicular to the longitudinal axis of the main frusto-conical portion of the preform.

In various embodiments, the method comprises the step of clamping the small diameter end holding surface with the small diameter clamp at an angle other than the slant angle of the main frusto-conical portion of the preform.

In various embodiments, the method comprises the step of clamping the small diameter end holding surface with the small diameter clamp at an angle that is perpendicular to the longitudinal axis of the main frusto-conical portion of the preform.

In various embodiments, the method comprises the step of clamping the small diameter end holding surface with the small diameter clamp at an angle that is in a range of 30° above or below an angle that is perpendicular to the longitudinal axis of the main frusto-conical portion of the preform.

In various embodiments, the method comprises the step of initiating coaxial movement between the punch, the large diameter clamp, and the small diameter clamp to form the lip skin.

In various embodiments, the method comprises the step of initiating coaxial movement only between the punch, the large diameter clamp, and the small diameter clamp to form the lip skin.

In various embodiments, the method comprises the step of moving the large diameter clamp and/or punch coaxially in relation to one another so that the external surface of the punch engages the internal surface of the preform.

In various embodiments, the method comprises the step of moving the small diameter clamp and/or the punch coaxially in relation to one another so that the preform is formed over the leading edge of the punch.

In various embodiments, the method comprises the step of moving the external blank holder into contact with a lower surface of the preform large diameter end holding surface.

In various embodiments, the method comprises moving the external die into contact with an upper surface of the preform large diameter end holding surface.

In various embodiments, the method comprises the step of moving the external die and the external blank holder towards one another until the projection on the clamping surface of the external blank holder becomes interlocked with the groove on the clamping surface of the external die so that the holding surface at the preform large diameter end is clamped between the clamping surfaces of the external die and the external blank holder at an angle other than the slant angle of the main frusto-conical portion of the preform.

In various embodiments, the method comprises the step of moving the external die and the external blank holder towards one another until the projection on the clamping surface of the external blank holder becomes interlocked with the groove on the clamping surface of the external die so that the holding surface at the preform large diameter end is clamped between the clamping surfaces of the external die and the external blank holder at an angle that is perpendicular to the longitudinal axis of the main frusto-conical portion of the preform.

In various embodiments, the method comprises the step of moving the external die and the external blank holder towards one another until the projection on the clamping surface of the external blank holder becomes interlocked with the groove on the clamping surface of the external die so that the holding surface at the preform large diameter end is clamped between the clamping surfaces of the external die and the external blank holder at an angle that is in a range of 30° above or below an angle that is perpendicular to the longitudinal axis of the main frusto-conical preform.

In various embodiments, the method comprises the step of applying force to the large diameter clamp to maintain the clamping force between the external die and the external blank holder.

In various embodiments, the method comprises the step of applying a set force to the large diameter clamp.

In various embodiments, the method comprises the step of initiating a first forming stage by maintaining the force applied to the large diameter clamp and moving the external die and external blank holder of the large diameter clamp in an axial direction relative to the punch or vice versa to force the internal wall of the preform over the punch.

In various embodiments, the method comprises the step of moving the internal blank holder of the small diameter clamp into contact with a lower surface of the small diameter end holding surface.

In various embodiments, the method comprises the step of moving the internal die of the small diameter clamp into contact with an upper surface of the small diameter end holding surface.

In various embodiments, the method comprises the step of moving the internal blank holder and the internal die towards one another so that the holding surface at the preform small diameter end is clamped between the internal die and the internal blank holder at an angle other than the slant angle of the main frusto-conical portion of the preform.

In various embodiments, the method comprises the step of moving the internal blank holder and the internal die towards one another so that the holding surface at the preform small diameter end is clamped between the internal die and the internal blank holder at an angle that is perpendicular to the longitudinal axis of the main frusto-conical portion of the preform.

In various embodiments, the method comprises the step of moving the internal blank holder and the internal die towards one another so that the holding surface at the preform small diameter end is clamped between the internal die and the internal blank holder at an angle that is in a range of 30° above or below an angle that is perpendicular to the longitudinal axis of the main frusto-conical portion of the preform.

In various embodiments, the method comprises the step of applying force to the small diameter clamp to maintain the clamping force between the internal die and the internal blank holder.

In various embodiments, the method comprises the step of adjusting the force between the internal die and the internal blank holder to prevent fracture of the preform during a second forming stage of the lip skin forming process.

In various embodiments, the method comprises the step of initiating a second forming stage by maintaining the clamping force applied to the large diameter clamp and adjusting the clamping force applied to the small diameter clamp whilst moving the internal blank holder and the internal die past the internal surface of the punch towards the large diameter end of the preform to mold the leading edge and inlet edge of the lip skin to its desired shape.

In various embodiments, the second forming stage is completed without the use of the internal blank holder and moving only the internal die past the internal surface of the punch towards the large diameter end.

In various embodiments, the method comprises the step of initiating a stretching stage by maintaining the clamping force applied to the large diameter clamp and adjusting the clamping force applied to the small diameter clamp whilst moving the punch relative to the small diameter clamp and large diameter clamp or vice versa to stretch the preform in order to accommodate spring back of the preform once molded to its desired lip skin shape.

In various embodiments, the stretching stage is completed without the use of the internal blank holder by adjusting the clamping force applied to the internal die only whilst moving the punch relative to the large diameter clamp and the internal die or vice versa to stretch the preform in order to accommodate spring back of the preform once molded into its desired lip skin shape.

In various embodiments, the stretching stage is completed without the use of the internal blank holder when the preform does not comprise an aperture at the small diameter end.

In various embodiments, the method comprises optimizing the stretch stage by moving the internal blank holder, internal die and large diameter clamp while maintaining the punch in a stationary position.

In various embodiments, the method comprises the step of moving the external die away from the external blank holder and the large diameter holding surface of the formed lip skin and moving the internal die away from the internal blank holder and small diameter holding surface of the formed lip skin, moving the punch and the internal blank holder away from the formed lip skin and removing the formed lip skin from the external blank holder.

In various embodiments, the method comprises the step of shearing and/or cutting the portion of the formed lip skin held between the internal blank holder and the internal die.

In various embodiments, the method comprises the step of shearing and/or cutting the portion of the formed lip skin held between the external die and the external blank holder.

In various embodiments, the method is a cold forming method.

In various embodiments, the method comprises heating of the preform.

In various embodiments, the method comprises heating at least a portion of the arrangement for forming a lip skin for a nacelle.

In various embodiments, the method comprises placing the arrangement for forming a lip skin for a nacelle and the preform in a heated environment prior to and/or during the forming process.

Accordingly, in another aspect, the present disclosure provides a method of forming a preform having a main frusto-conical portion, a small diameter end having a holding surface and a large diameter end having a holding surface, the method comprising the step of clamping a blank against a frusto-conical mandrel.

In various embodiments, the method comprises the step of clamping a circular blank against a frusto-conical mandrel.

In various embodiments, the method comprises the step of clamping the blank against an upper surface of the frusto-conical mandrel.

In various embodiments, the method comprises the step of rotating the clamp and the frusto-conical mandrel.

In various embodiments, the method comprises the step of applying force to the blank via a shear form tool.

In various embodiments, the method comprises the step of applying force to the blank at a region not clamped against the upper surface of the frusto-conical mandrel.

In various embodiments, the method comprises the step of applying force to the blank at a region immediately outside the circumference of the frusto-conical mandrel.

In various embodiments, the method comprises the step of moving the shear form tool traverse to the frusto-conical mandrel so that a portion of the blank is forced against the slant surface of the frusto-conical mandrel.

In various embodiments, the method comprises the step of moving the shear form tool traverse to the frusto-conical mandrel so that a portion of the blank intermediate the clamped portion and a portion distal to the center of the blank is forced against the slant surface of the frusto-conical mandrel.

In various embodiments, the method comprises the step of moving the shear form tool traverse to the frusto-conical mandrel so that a portion of the blank intermediate the clamped portion and a portion distal to the center of the blank is forced against the slant surface of the frusto-conical mandrel such that the portion of the blank forced against the slant surface of the frusto-conical mandrel forms the main frusto-conical portion of the preform and the portion distal to the center of the blank forms the large diameter end holding surface of the preform.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 shows a sectional perspective view of an arrangement for forming a lip skin for a nacelle, in accordance with various embodiments.

FIG. 2 shows a perspective view of a preform prior to the forming process for forming a lip skin for a nacelle, in accordance with various embodiments.

FIG. 3 shows a second sectional perspective view of an arrangement for forming a lip skin for a nacelle at a first stage in the forming process, in accordance with various embodiments.

FIG. 4 shows a third sectional perspective view of an arrangement for forming a lip skin for a nacelle after a first stage of the forming process, in accordance with various embodiments.

FIG. 5 shows a fourth sectional perspective view of an arrangement for forming a lip skin for a nacelle at a second stage of the forming process, in accordance with various embodiments.

FIG. 6 shows a fifth sectional perspective view of an arrangement for forming a lip skin for a nacelle after a second stage of the forming process, in accordance with various embodiments.

FIG. 7 shows a second perspective view of a preform prior to the first stage of the forming process for forming a lip skin for a nacelle, in accordance with various embodiments.

FIG. 8 shows a third perspective view of a preform after the first stage of the forming process and before a second stage of the forming process, in accordance with various embodiments.

FIG. 9 shows a fourth perspective view of a preform after the second stage of the forming process, in accordance with various embodiments.

FIG. 10 shows a sectional perspective view of a preform prior to the first stage of the forming process for forming a lip skin for a nacelle, in accordance with various embodiments.

FIG. 11 shows a second sectional perspective view of a preform after the first stage of the forming process and before a second stage of the forming process, in accordance with various embodiments.

FIG. 12 shows a third sectional perspective view of a preform after the second stage of the forming process, in accordance with various embodiments.

FIG. 13 shows a sectional perspective view of a formed lip skin, in accordance with various embodiments.

FIG. 14 shows a sixth perspective view of an arrangement for forming a lip skin for a nacelle at a second stage of the forming process, in accordance with various embodiments.

FIG. 15 shows the arrangement at a second forming stage, in accordance with various embodiments, in accordance with various embodiments.

FIG. 16 shows the arrangement at a stretching stage, in accordance with various embodiments, in accordance with various embodiments.

FIG. 17 shows an apparatus for forming a preform, in accordance with various embodiments.

FIG. 18 illustrates a method of forming a preform, in accordance with various embodiments.

FIG. 19 shows a preform after its formation, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step.

As used herein, “slant angle” means the angle between the longitudinal axis of the main frusto-conical portion of the preform and the slant of the main frusto-conical portion of the preform, prior to forming.

Various embodiments of the present disclosure provide an arrangement for forming an annular component, such as a lip skin for a nacelle, from a preform having a main frusto-conical portion, a small diameter end having a holding surface and a large diameter end having a holding surface, the arrangement comprising a punch shaped to correspond to the shape of a lip skin, a small diameter clamp configured to clamp the preform at or about its small diameter end, a large diameter clamp configured to clamp the preform at or about its large diameter end, wherein the punch, small diameter clamp, and large diameter clamp are configured to move coaxially relative to one another to form a lip skin, wherein the small diameter clamp is configured to clamp the small diameter end holding surface and/or the large diameter clamp is configured to clamp the large diameter end holding surface on the preform at an angle other than the slant angle of the main frusto-conical portion of the preform. The holding surface inclining away from the main frusto-conical portion tends to enable enhanced clamping of the preform during the forming process.

Clamping the preform at an angle other than the slant angle of the main frusto-conical portion of the preform reduces the risk of slippage of the preform through the large diameter clamp and small diameter clamp, during forming. This is in contrast to other processes where clamping occurs on a slanted portion of the preform at an angle equal to the slant angle of the conical/frusto-conical preform.

In various embodiments, the present disclosure provides a method and arrangement for forming a nacelle lip skin with improved capability and reduced risk of breaking the pre-form material.

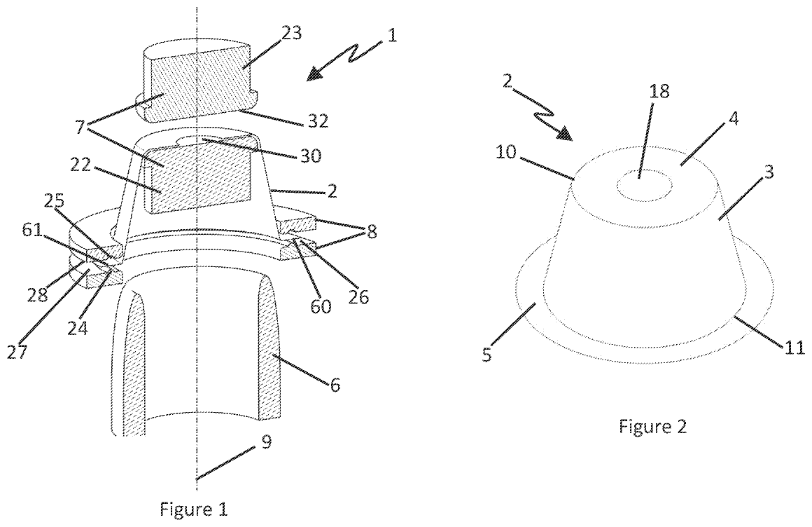

With reference to FIG. 1 through FIG. 6, there is shown an arrangement, indicated generally by reference numeral 1, for forming a lip skin for a nacelle from a preform 2 having a main frusto-conical portion 3, a first or small diameter end 10 having a holding surface 4 and a second or large diameter end 11 having a holding surface 5 (the large diameter end 11 having a larger outer diameter than the small diameter end 10), in accordance with various embodiments. The arrangement has a punch 6 which is shaped to correspond to the shape of a lip skin, a small diameter clamp 7 for clamping the holding surface 4 of the small diameter end 10 (e.g., by engaging opposing sides of the holding surface 4), and a large diameter clamp 8 for clamping the holding surface 5 of the large diameter end 11 (e.g., by engaging opposing sides of the holding surface 5). In use, the punch 6, small diameter clamp 7, and large diameter clamp 8 are arranged along a centerline 9.

In various embodiments, the arrangement has an actuator or actuation means having die cushion pins 70 (see FIG. 14) to cause the punch 6, small diameter clamp 7 and large diameter clamp 8 to move coaxially in relation to one another.

In various embodiments, the preform 2 is formed from a single frusto-conical piece (e.g., of an integral configuration or a one-piece structure).

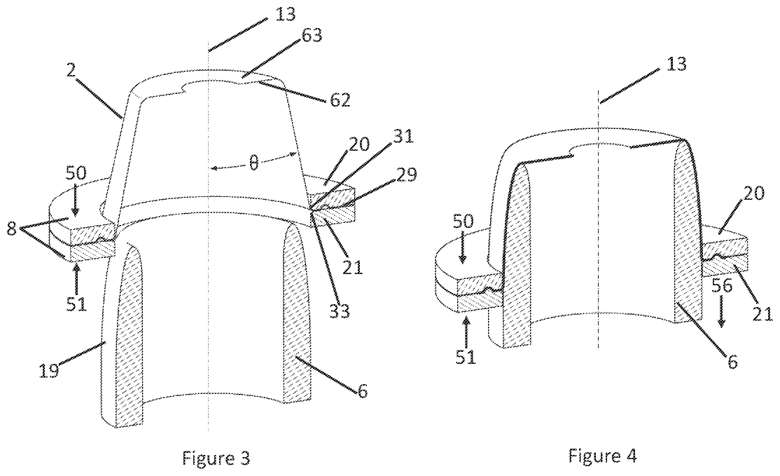

The large diameter end holding surface 5 is located on a portion of the preform 2 outside the main frusto-conical portion 3 (holding surface 5 extends beyond the outer perimeter of main frusto-conical portion 3). The small diameter end holding surface 4 is located on a portion of the preform 2 inside the main frusto-conical portion 3 (e.g., holding surface 4 does not extend beyond the outer perimeter of main frusto-conical portion 3). The main frusto-conical portion 3 extends between the holding surface 5 of the large diameter end 11 and the holding surface 4 of the small diameter end 10 (e.g., the outer diameter of the frusto-conical portion 3 is progressively reduced proceeding from the large diameter end 11 to the small diameter end 10; the frusto-conical portion 3 converges toward the longitudinal axis 13 of the main frusto-conical portion 3 of the preform 2 (FIG. 3) proceeding from the large diameter end 11 to the small diameter end 10). The holding surface 5 of the large diameter end 11 forms a flange around the circumference of the preform 2 at its large diameter end 11. The large diameter end holding surface 5 extends from the circumference of the large diameter end 11 of the main frusto-conical portion 3 at an angle (also referred to herein as a second angle) other than the slant angle (e.g., slant angle θ shown in FIG. 3) of the main frusto-conical portion 3. In various embodiments, the large diameter end holding surface 5 extends from the circumference of the large diameter end 11 of the main frusto-conical portion 3 at an angle that is perpendicular to the longitudinal axis 13 of the main frusto-conical portion 3 of the preform 2. However, in other embodiments, the angle may also be at an angle in a range of 30° above or below an angle perpendicular to the longitudinal axis 13 of the main frusto-conical portion 3 of the preform 2 (i.e., between 60° and 120° with respect to the longitudinal axis 13).

The holding surface 4 of the small diameter end 10 of the preform 2 extends or projects inwardly from the circumference or outer perimeter of the small diameter end 10 of the main frusto-conical portion 3 towards the center of the small diameter end 10 of the main frusto-conical portion 3 at an angle (also referred to herein as a first angle) other than the slant angle of the main frusto-conical portion 3. In various embodiments, the holding surface 4 of the small diameter end 10 of the preform 2 projects inwardly from the circumference of the small diameter end 10 of the main frusto-conical portion 3 at an angle that is perpendicular the longitudinal axis 13 of the main frusto-conical portion 3. However, in other embodiments, the angle may also be at an angle that is in a range of 30° above or below an angle that is perpendicular to the longitudinal axis 13 of the main frusto-conical portion 3 of the preform 2.

In use, the small diameter clamp 7 is configured to clamp the preform 2 at the holding surface 4 of the small diameter end 10 of the preform 2 at an angle other than the slant angle of the main frusto-conical portion 3 of the preform 2 (e.g., the small diameter clamp 7 engages a portion of the preform 2 (e.g., opposing sides of the holding surface 4) that is disposed in a different orientation than the frusto-conical portion 3). In various embodiments, the small diameter clamp 7 is configured to clamp the preform 2 at the holding surface 4 of the small diameter end 10 of the preform 2 at an angle that is perpendicular to the longitudinal axis 13 of the main frusto-conical portion 3 of the preform 2. In other embodiments, the small diameter clamp 7 may also clamp the holding surface 5 at an angle in a range of 30° above or below an angle that is perpendicular to the longitudinal axis 13 of the main frusto-conical portion 3 of the preform 2.

The large diameter clamp 8 is configured to clamp the preform 2 at the holding surface 5 of the large diameter end 11 of the preform 2 at an angle other than the slant angle of the main frusto-conical portion 3 of the preform 2 (e.g., the large diameter clamp 8 engages a portion of the preform 2 (e.g., opposing sides of the holding surface 5) that is disposed in a different orientation than the frusto-conical portion 3). In various embodiments, the large diameter clamp 8 is configured to clamp the preform 2 at the holding surface 5 of the large diameter end 11 of the preform 2 at an angle that is perpendicular to the longitudinal axis 13 of the main frusto-conical portion 3 of the preform 2. However, the large diameter clamp 8 may clamp the holding surface 5 at any angle that is in a range of 30° above or below an angle that is perpendicular to the longitudinal axis 13 of the main frusto-conical portion 3 of the preform 2.

The holding surface 5 of the large diameter end 11 is flat, prior to clamping. The holding surface 4 of the small diameter end 10 is flat, prior to clamping. This tends to reduce the risk of wrinkling of the preform 2 during forming, permits less complexity of the large diameter clamp 8 and small diameter clamp 7, and reduces the holding force on the preform 2. This is in contrast to clamping the preform 2 on curved portions (e.g. on the frusto-conical portion 3) at an angle equal to the slant angle of the conical/frusto-conical portion 3 of the preform 2.

In various embodiments, the preform 2 has an open end at its large diameter end 11 and the holding surface 4 of the small diameter end 10 of the preform 2 comprises an aperture 18. The holding surface 4 of the small diameter end 10 of the preform 2 forms an annular ring around the aperture 18. The aperture 18 allows the material of the holding surface 4 of the small diameter end 10 to expand radially outwardly (e.g., away from the longitudinal axis 13) from the original aperture 18, increasing the size of the aperture 18, as the preform 2 is being formed. In various embodiments, the holding surface 4 and aperture 18 are symmetrical and the material of holding surface 4 around the circumference of aperture 18 expands uniformly away from the original aperture 18. This tends to enhance formability of the preform 2 at its small diameter end 10 away from the center of the preform 2, during forming.

The preform 2 is formed into a lip skin using a single punch 6, large diameter clamp 8 and small diameter clamp 7. Using a single punch 6 tends to enhance the ease of the forming process by eliminating steps between the forming stages of the preform 2. This is in contrast to other processes which may require components to be changed between forming stages. The punch 6 is annular and has an external surface 19 shaped to correspond to the internal surface of the desired finished lip skin. The large diameter clamp 8 has a first clamp portion 20 (also referred to herein as an external die) and a second clamp portion 21 (also referred to herein as an external blank holder). The external die 20 and the external blank holder 21 (“external” being relative to the punch 6 (e.g., the die 20 and blank holder 21 are “outward” of the punch 6 during forming operations) may be two distinct component (i.e., two separate pieces). The external die 20 and the external blank holder 21 are operable to move towards and/or away from one another, axially (i.e., parallel to and along longitudinal axis 13). The external die 20 and the external blank holder 21 are operable to move towards and/or away from one another, coaxially. The external die 20 and external blank holder 21 are annular. The large diameter clamp 8 is adapted for leaving a portion (i.e., an inner surface) of the preform 2 accessible. In use, the large diameter clamp 8 and/or the punch 6 is configured to translate axially toward one another so that the punch 6 comes into contact with the accessible portion of the preform 2 for forming the preform 2 between the large diameter end 11 (also referred to herein as a trailing edge) and the small diameter end 10 (also referred to herein as a leading edge) into the shape of a lip skin during a forming stage of the forming process.

The small diameter clamp 7 has an internal blank holder 22 and an internal die 23 (“internal” being relative to the punch 6 (e.g., blank holder 22 and die 23 are “inward” of the punch 6 during forming operations). The internal blank holder 22 and the internal die 23 are operable to move toward and/or away from one another, axially. The internal blank holder 22 and internal die 23 are operable to move toward and/or away from one another coaxially. The internal blank holder 22 and the internal die 23 may be the same in shape and size. This tends to enhance the ease of manufacture by reducing the overall component count of the apparatus. The internal blank holder 22 and the internal die 23 are shaped to correspond with the shape of the punch 6. More specifically, the internal blank holder 22 and the internal die 23 are shaped to correspond with the internal surface of the punch 6. The internal blank holder 22 and internal die 23 have an arcuate clamping portion 71, 72 to correspond to the shape of the punch 6.

In various embodiments, the large diameter clamp 8 has a lock bead to increase gripping capacity of the large diameter clamp 8 on the preform. The large diameter clamp 8 has at least one projection 24 and at least one groove 25 (FIG. 1) to increase gripping capacity of the large diameter clamp 8 on the preform 2. In various embodiments, the large diameter clamp 8 has one projection 24 (e.g., annular) and one groove 25 (e.g., annular). However, in other embodiments, the large diameter clamp 8 may have any number of projections or grooves.

The external blank holder 21 of the large diameter clamp 8 has a clamping surface 26 with a flat portion 27. In various embodiments, the flat portion 27 spans nearly the full surface area of the clamping surface 26. In various embodiments, the projection 24 is an upward projection and is located on the clamping surface 26 of the external blank holder 21. In various embodiments, clamping surface 26 extends continuously around the entire circumference of preform 2. In use, the clamping surface 26 of the external blank holder 21 is at an angle other than the slant angle of the main frusto-conical portion 3 of the preform 2. In various embodiments, the clamping surface 26 of the external blank holder 21 is at an angle that is perpendicular to the longitudinal axis 13 of the main frusto-conical portion 3 of the preform 2. However, in other embodiments, the clamping surface 26 of the external blank holder 21 may be at any angle that is in a range of 30° above or below an angle that is perpendicular to the longitudinal axis 13 of the main frusto-conical portion 3 of the preform 2.

The external die 20 of the large diameter clamp 8 has a clamping surface 28 with a flat portion 29. The flat portion 29 spans almost the entire clamping surface 28. In various embodiments, groove 25 is located on the clamping surface 28 of the external die 20 and is shaped and positioned to correspond with the projection 24 on the external blank holder 21. In various embodiments, clamping surface 28 extends continuously around the entire circumference of preform 2. In use, the clamping surface 28 of the external die 20 is at an angle other than the slant angle of the main frusto-conical portion 3 of the preform 2. In various embodiments, the clamping surface 28 of the external die 20 is at an angle that is perpendicular to the longitudinal axis 13 of the main frusto-conical portion 3. In other embodiments, the clamping surface 28 of the external die 20 may be at any angle that is in a range of 30° above or below an angle that is perpendicular to the longitudinal axis of the main frusto-conical portion 3.

The clamping surface 26 of the external blank holder 21 is shaped and positioned to correspond to a lower surface 60 of the holding surface 5 of the large diameter end 11 of the preform 2 and the clamping surface 28 of the external die 20. The clamping surface 28 of the external die 20 is shaped and positioned to correspond with an upper surface 61 of the holding surface 5 of the large diameter end 11 of the preform 2 and the clamping surface 26 of the external blank holder 21.

The external die 20 and external blank holder 21 have an internal surface shaped to allow movement of the punch 6 past the internal surface of the external die 20 and external blank holder 21 during the lip skin forming process. In use, the external die 20 forms a ring around the external surface of the main frusto-conical portion 3 of the preform 2. The external die 20 may have an internal lower edge which is curved to form a fillet radius 31. The external blank holder 21 may have an internal upper edge which is curved to form a fillet radius 33. The fillet radius 31 of the external die 20 and the fillet radius 33 of the external blank holder 21 provides a smooth interface with the preform 2 to reduce the risk of tearing of the preform 2 as it is formed around the edge of the external die 20. In use, the external die 20 and the external blank holder 21 clamp the holding surface 5 of the large diameter end 11 of the preform 2 at an angle other than the slant angle of the main frusto-conical portion 3 of the preform. In various embodiments, the external die 20 and the external blank holder 21 clamp the holding surface 5 of the large diameter end 11 of the preform 2 at an angle that is perpendicular to the longitudinal axis 13 of the main frusto-conical portion. However, in other embodiments the external die 20 and the external blank holder 21 may clamp the holding surface 5 of the large diameter end 11 at any angle that is in a range of 30° above or below an angle that is perpendicular to the longitudinal axis 13 of the main frusto-conical portion 3 of the preform 2.

The internal blank holder 22 has a clamping surface 30. Internal die 23 has a clamping surface 32. In various embodiments, clamping surfaces 30 and 32 are flat. This corresponds to the flat holding surface 4 and permits a strong holding force on the holding surface 4 of the small diameter end 10 of the preform 2. The internal blank holder 22 and internal die 23 have an outer surface shaped to correspond with the internal surface of the punch 6 with marginal room between for the preform 2 and to enable movement of the internal blank holder 22 and the internal die 23 past the internal surface of the punch 6 during a second forming stage of the forming process. The internal blank holder 22 has a main body 12 with a cylindrical outer surface. The internal die 23 has a main body 14 with a cylindrical outer surface.

The internal die 23 has a draw face. In various embodiments, the clamping surface 32 of internal die 23 is a draw face. In various embodiments, the draw face is flat and smooth. Having a smooth draw face tends to reduce friction between the material of the holding surface 4 of the small diameter end and the internal die 23 as the material expands radially outwardly away from the center of the small diameter end of the preform 2. The internal blank holder 22 and the internal die 23 are shaped and positioned to optimize flow of the preform 2. The outer lower edge of the internal die 23 is curved to form a fillet radius 39. The lower upper edge of the internal blank holder 22 is curved to form a fillet radius 40. The fillet radius 39, 40 allows material flow of the holding surface 4, of the small diameter end 10, to move away from its original position between the internal blank holder 22 and the internal die 23 as it expands radially outwardly towards the internal surface of the punch 6 as the internal blank holder 22 and internal die 23 move past the internal surface of the punch 6, during forming of the internal surface of the lip skin. The fillet radius 39, 40 allows the material of the holding surface 4, of the small diameter end 10, to bend smoothly around the fillet radius 39 as it flows out of an area between the internal blank holder 22 and internal die 23 during forming of the internal surface of the lip skin.

In use, the clamping surface 32 of internal die 23 and the clamping surface 30 of the internal blank holder 22 are at an angle other than the slant angle of the main frusto-conical portion 3 of the preform 2. In various embodiments, the clamping surface 32 of the internal die 23 and the clamping surface 30 of the internal blank holder 22 are positioned at an angle that is perpendicular to the longitudinal axis 13 of the main frusto-conical portion 3 of the preform 2. However, in other embodiments, the clamping surface 32 of the internal die 23 and the clamping surface 30 of the internal blank holder 22 are positioned at an angle that is 30° above or below an angle that is perpendicular to the longitudinal axis 13 of the frusto-conical portion 3 of the preform 2.

In use, and referring to FIG. 1 through FIG. 14 there is shown, a preform 2 having a main frusto-conical portion 3, a small diameter end 10 having a holding surface 4 and a large diameter end 11 having a holding surface 5. The preform 2 is clamped at the small diameter end holding surface 4 with a small diameter clamp 7 and/or large diameter end holding surface 5 with a large dimeter clamp 8, wherein the clamping angle is an angle other than the slant angle of the main frusto-conical portion 3 of the preform 2. The preform 2 is drawn over a punch 6 to form a lip skin.

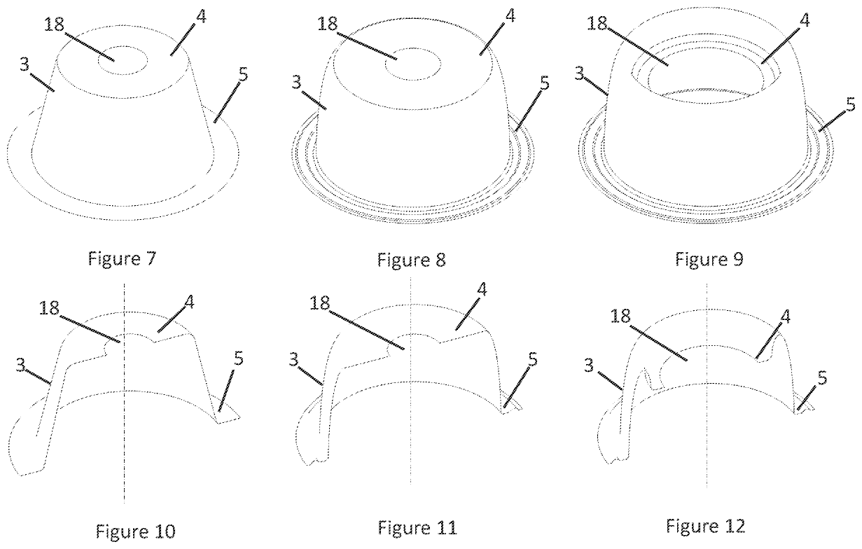

In various embodiments, in use, the preform 2, as shown in FIG. 2, FIG. 7 and FIG. 10 is inserted onto the arrangement 1, the large diameter end holding surface 5 is clamped between an external die 20 and an external blank holder 21 at an angle that is perpendicular to the longitudinal axis 13 of the main frusto-conical portion 3 of the preform 2. However, the clamping angle of the large diameter end holding surface 5 may be at any angle in a range of 30° above or below an angle that is perpendicular to the longitudinal axis 13 of the main frusto-conical portion 3 of the preform 2. Referring to FIG. 3 and FIG. 4, the external blank holder 21 is axially moved into contact with a lower surface 60 (shown in FIG. 1) of the preform large diameter end holding surface 5. The external die 20 is moved into contact with an upper surface 61 (shown in FIG. 1) of the preform large diameter end holding surface 5. In use, and referring to FIG. 3 and FIG. 4, the external die 20 and the external blank holder 21 are moved towards one another by linear actuation forces 50 and 51 until the projection 24 on the clamping surface 26 of the external blank holder 21 becomes interlocked with the groove 25 on the clamping surface 28 of the external die 20 so that the holding surface 5 at the preform large diameter end 11 is clamped between the clamping surfaces 28, 26 of the external die 20 and the external blank holder 21 at an angle other than the slant angle of the main frusto-conical portion 3 of the preform 2. In various embodiments, the holding surface 5 is clamped between the clamping surfaces 28, 26 of the external die 20 and the external blank holder 21 at an angle that is perpendicular to the longitudinal axis 13 of the main frusto-conical portion. In other embodiments, the holding surface 5 is clamped between the clamping surfaces 28, 26 of the external die 20 and the external blank holder 21 at an angle that is in a range of 30° above or below an angle that is perpendicular to the longitudinal axis 13 of the main frusto-conical portion 3.

In use, and referring to FIG. 3 and FIG. 4, a first forming stage of the forming process is illustrated. The external die 20 and external blank holder 21 are displaced axially by linear actuation forces 50 and 56 relative to the punch 6 to force the internal wall of the preform 2 over the punch 6 so that the main frusto-conical portion 3 corresponds to the shape of a lip skin, as illustrated in FIG. 8 and FIG. 11.

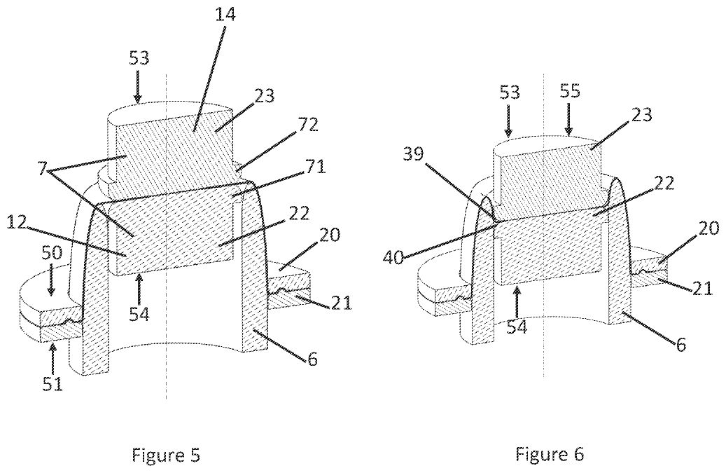

In use, the small diameter end holding surface 4 is clamped between an internal die 23 and an internal blank holder 22 at an angle that is perpendicular to the longitudinal axis 13 of the main frusto-conical portion 3 of the preform 2, in various embodiments. However, the clamping angle of the small diameter end holding surface 4 may be at any angle in a range of 30° above or below an angle that is perpendicular to the longitudinal axis of the main frusto-conical portion 3 of the preform 2. The internal blank holder 22 of the small diameter clamp 7 is moved into contact with a lower surface 62 (shown in FIG. 3) of the small diameter end holding surface 4. The internal die 23 of the small diameter clamp 7 is moved into contact with an upper surface 63 (shown in FIG. 3) of the small diameter end holding surface 4. Referring to FIG. 5 and FIG. 6, the internal blank holder 22 and the internal die 23 are moved towards one another by linear actuation forces 53 and 54 so that the holding surface 4 at the preform small diameter end 10 is clamped between the internal die 23 and the internal blank holder 22 at an angle other than the slant angle of the main frusto-conical portion 3 of the preform 2. In various embodiments, the holding surface 4 is clamped between the internal die 23 and the internal blank holder 22 at an angle that is perpendicular to the longitudinal axis 13 of the main frusto-conical portion 3 of the preform 2. In other embodiments, the holding surface 4 is clamped between the internal die 23 and the internal blank holder 22 at an angle that is in a range of 30° above or below an angle that is perpendicular to the longitudinal axis 13 of the main frusto-conical portion 3 of the preform 2.

Referring to FIG. 5 and FIG. 6, a second forming stage of the forming process is illustrated. While maintaining axial forces 50, 51 and adjusting the forces 53, 54, the internal blank holder 22 and the internal die 23 are displaced by actuation force 55, towards the large diameter end 11 of the preform 2, to draw the holding surface 4 over the leading edge of the punch 6, forming the preform 2 into the shape of a lip skin as shown in FIG. 9 and FIG. 12.

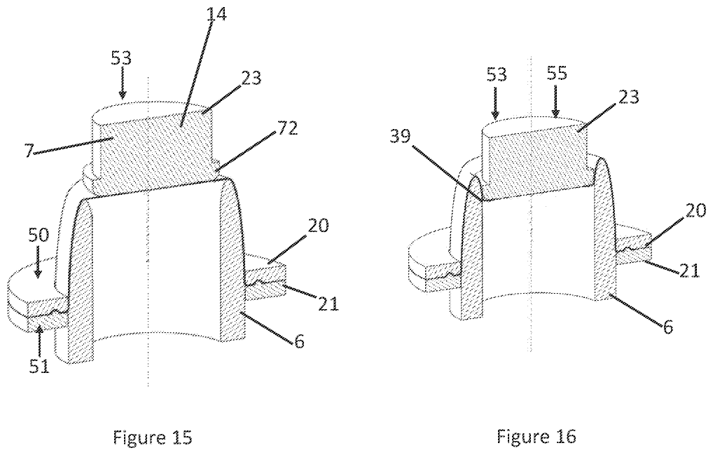

Referring now to FIG. 15 and FIG. 16, there is illustrated an embodiment where the second forming stage is completed without the use of the internal blank holder 22 and by moving only the internal die 23 past the internal surface of the punch 6 towards the large diameter end 11 of the preform 2. With momentary reference to the embodiment illustrated in FIG. 6, in use, a stretching force may be applied to the preform 2 by adjusting force 55 on the internal blank holder 22 and internal die 23 and displacing the punch 6, relative to the large diameter clamp 8 and small diameter clamp 7, towards the internal blank holder 22 and the internal die 23 to minimize springback of the preform 2. Referring to FIG. 16, there is illustrated an embodiment where the stretching force is applied to the preform 2, without the use of the internal blank holder 22, by adjusting force 55 on the internal die 23 and displacing the punch 6, relative to the large diameter clamp 8, towards the internal die 23. In various embodiments, the preform 2 does not comprise an aperture at the small diameter end 10. Stated differently, the small diameter end of the preform 2 may be closed, in accordance with various embodiments.

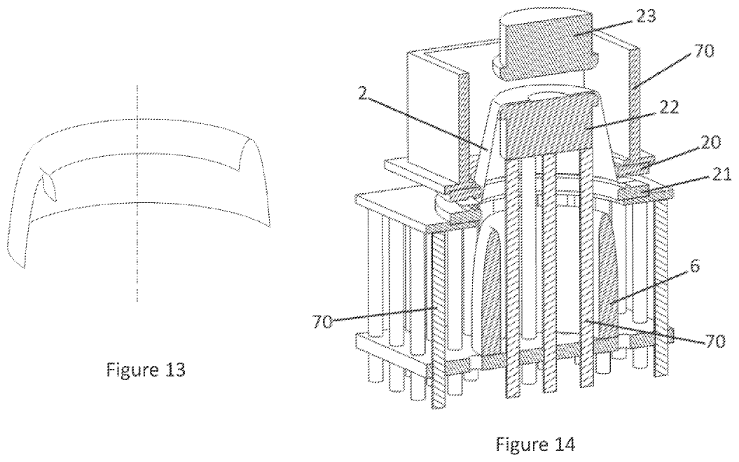

When the above stages are complete, forces, 50, 51, 53, and 55 are released, the external die 20 is moved away from the external blank holder 21 and the large diameter holding surface 5 of the formed lip skin, and the internal die 23 is moved away from preform 2 (and the internal blank holder 22 in embodiments where the internal blank holder 22 is present) and small diameter holding surface 4 of the formed lip skin. The formed lip skin as shown in FIG. 9 is removed from the external blank holder 21 by withdrawing the punch 6 and the internal blank holder 22 (in embodiments where the internal blank holder 22 is present). The portion of the formed lip skin held between the internal blank holder 22 (in embodiments where the internal blank holder 22 is present) and the internal die 23 is cut away and the portion of the formed lip skin held between the external die 20 and external blank holder 21 is cut away forming the final lip skin shape as illustrated in FIG. 13.

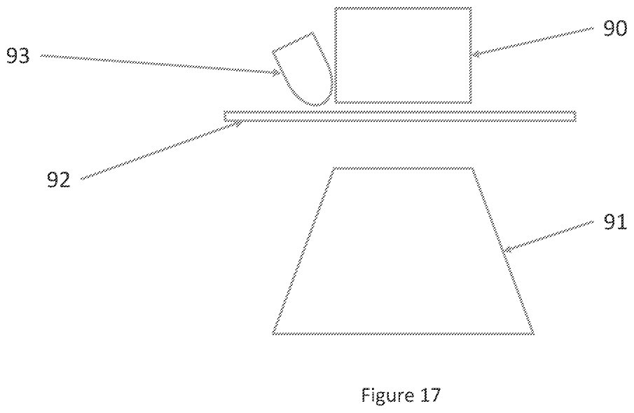

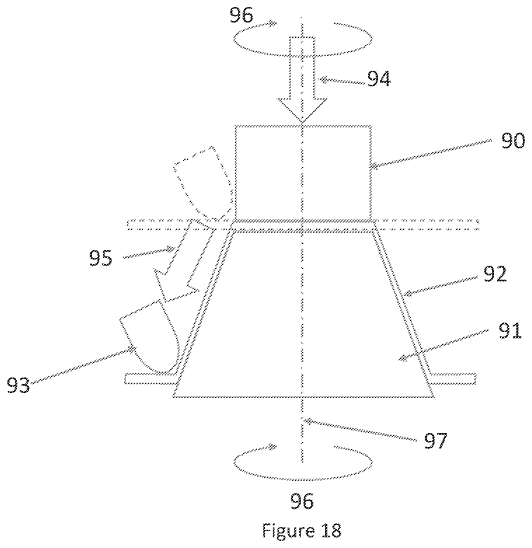

Referring now to FIG. 17 and FIG. 18, a preform having a main frusto-conical portion, a small diameter end having a holding surface and a large diameter end having a holding surface is formed using a blank 92 which is clamped against an upper surface of a frusto-conical mandrel 91 via clamp 90. The blank 92 is circular. The blank 92 may be disc shaped. The clamp 90 and frusto-conical mandrel 91 are rotated in the direction 96 about axis 97. Force is applied to the blank 92 via a shear form tool 93. The force is applied to the blank 92. The blank 92 is sheared, reducing the thickness of the blank 92 at a region not clamped against the upper surface of the frusto-conical mandrel 91 but at a region immediately outside the circumference of the frusto-conical mandrel 91, as illustrated in FIG. 18.

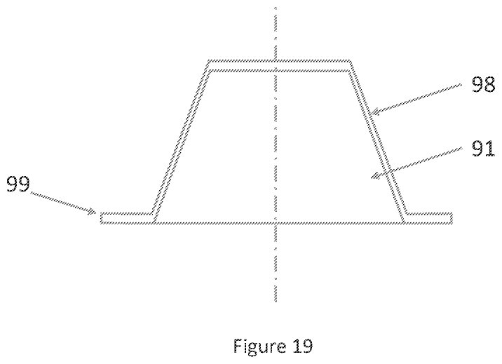

The shear form tool 93 is moved traverse to the frusto-conical mandrel 91, as indicated by arrow 95, so that a portion of the blank 92 is forced against the slant surface of the frusto-conical mandrel 91. The shear form tool 93 is moved transverse to the frusto-conical mandrel 91 so that a portion of the blank 92 intermediate the clamped portion and a portion distal to the center of the blank 92 is forced against the slant surface of the frusto-conical mandrel 91 such that the portion of the blank 92 forced against the slant surface of the frusto-conical mandrel 91 forms the main frusto-conical portion 98 of the preform and the portion distal to the center of the blank forms the large diameter end holding surface 99 of the preform, as illustrated in FIG. 19. Forming the preform in this way may reduce or eliminate trimming of the blank. This is in contrast to other methods which require the preform to be trimmed before use.

The skilled person will appreciate that all preferred or optional features of the present disclosure described with reference to only some aspects or embodiments of the present disclosure may be applied to all aspects of the present disclosure.

It will be appreciated that optional features applicable to one aspect of the present disclosure can be used in any combination, and in any number. Moreover, they can also be used with any of the other aspects of the present disclosure in any combination and in any number. This includes, but is not limited to, the dependent claims from any claim being used as dependent claims for any other claim in the claims of this application.

In relation to the detailed description of the different embodiments of the present disclosure, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

The features disclosed in the foregoing description or the following drawings, expressed in their specific forms or in terms of a means for performing a disclosed function, or a method or a process of attaining the disclosed result, as appropriate, may separately, or in any combination of such features be utilized for realizing the present disclosure in diverse forms thereof.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An arrangement for forming an annular component, comprising:
a small diameter clamp for retaining a first holding surface of a small diameter end of a preform, the preform comprising a main frusto-conical portion, the small diameter end having the first holding surface, and a large diameter end having a second holding surface;
a large diameter clamp for retaining the second holding surface of the large diameter end of the preform; and
a punch having an external surface contour shaped to correspond to a shape of a profile of the annular component;
wherein the large diameter clamp is configured to clamp the second holding surface at an angle other than a slant angle of the main frusto-conical portion of the preform.

2. The arrangement of claim 1, wherein the large diameter clamp comprises an external die and an external blank holder configured to receive the second holding surface therebetween.

3. The arrangement of claim 2, wherein one of the external die or the external blank holder comprises a projection and the other of the external die or the external blank holder comprises a groove, wherein in response to the external die and the external blank holder being moved towards one another the projection becomes interlocked with the groove so that the second holding surface is clamped between the clamping surfaces of the external die and the external blank holder at the angle other than the slant angle of the main frusto-conical portion.

4. The arrangement of claim 1, wherein the small diameter clamp comprises an internal die and an internal blank holder configured to receive the first holding surface therebetween.

5. The arrangement of claim 1, wherein the punch, the small diameter clamp, and the large diameter clamp are configured to move coaxially relative to one another to form the annular component from the preform.

6. The arrangement of claim 1, wherein the small diameter clamp is configured to clamp the first holding surface at another angle other than the slant angle of the main frusto-conical portion of the preform.

7. The arrangement of claim 1, wherein the first holding surface of the small diameter end extends from a circumference of the small diameter end at a or the other angle other than the slant angle of the frusto-conical portion.

8. The arrangement of claim 6, wherein at least one of the angle or the other angle is in a range of 30° above or below an angle that is perpendicular to a longitudinal axis of the main frusto-conical portion of the preform.

9. The arrangement of claim 8, wherein at least one of the angle or the other angle is perpendicular to the longitudinal axis of the main frusto-conical portion of the preform.

10. The arrangement of claim 1, wherein the first holding surface of the small diameter end projects inwardly from the main frusto-conical portion.

11. The arrangement of claim 1, wherein the second holding surface of the large diameter end projects outwardly from the main frusto-conical portion.

12. The arrangement of claim 1, wherein the second holding surface of the large diameter end extends from a circumference of the large diameter end at the angle other than the slant angle of the frusto-conical portion.

13. The arrangement of claim 1, wherein the annular component is a lip skin for a nacelle.

14. A method of forming an annular component, the method comprising the steps of:
clamping at least one of a first holding surface or a second holding surface at an angle other than a slant angle of a main frusto-conical portion of a preform, wherein the preform comprises the main frusto-conical portion, a small diameter end having the first holding surface, and a large diameter end having the second holding surface; and
drawing the preform over a punch to form the annular component.

15. The method of claim 14, wherein the step of clamping at least one of the first holding surface or the second holding surface comprises clamping the second holding surface of the large diameter end with a large diameter clamp at the angle other than the slant angle of the main frusto-conical portion.

16. The method of claim 15, wherein the step of clamping at least one of the first holding surface or the second holding surface comprises clamping the first holding surface of the small diameter end with a small diameter clamp at the angle other than the slant angle of the main frusto-conical portion.

17. The method of claim 14, wherein the angle is in a range of 30° above or below an angle that is perpendicular to a longitudinal axis of the main frusto-conical portion of the preform.

18. The method of claim 17, wherein the angle is perpendicular to the longitudinal axis of the main frusto-conical portion of the preform.

19. The method of claim 16, further comprising initiating coaxial movement between the punch, the large diameter clamp, and the small diameter clamp to form the lip skin.

20. The method of claim 16, further comprising the step of moving an external die of the large diameter clamp and an external blank holder of the large diameter clamp towards one another until a projection on a clamping surface of the external blank holder becomes interlocked with a groove on a clamping surface of the external die so that the second holding surface is clamped between the clamping surfaces of the external die and the external blank holder at the angle other than the slant angle of the main frusto-conical portion.
